(19) United States
(12) Patent Application Publication
(10) Pub. No.: US 2015/0205435 A1
(43) Pub. Date: Jul. 23, 2015

(54) PORTABLE TERMINAL, CONTROL METHOD AND CONTROL PROGRAM

(71) Applicant: KYOCERA Corporation, Kyoto-shi, Kyoto (JP)

(72) Inventor: Osamu Takae, Kyoto (JP)

(21) Appl. No.: 14/424,977

(22) PCT Filed: Aug. 28, 2013
(86) PCT No.: PCT/JP2013/005069

§ 371 Date: Feb. 27, 2015

(30) Foreign Application Priority Data
Aug. 29, 2012 (JP) 2012-188481

(51) Int. Cl. G06F 3/041; G06F 3/01

(52) U.S. Cl. CPC G06F 3/0418; G06F 3/017

(57) ABSTRACT

A portable terminal is provided that appropriately suppresses operating error when a user is holding the portable terminal. The portable terminal executes processing corresponding to a contact position on a touch panel and includes a detector that detects an orientation change of the portable terminal and a controller storing information defining a predefined region having a high probability of erroneous contact by a user during the orientation change. The controller disables input due to contact within the predefined region during a predefined time period after detection of the orientation change and the predefined region is within a portion of a peripheral region of the touch panel.

The present application is a 371 National Stage Application based on International Application No. PCT/JP2013/005069 filed on Aug. 28, 2013, which claims priority to Japanese Application NO. 2012-188481 filed on Aug. 29, 2013. Each of the above referenced applications is incorporated by reference herein in its entirety.

### TECHNICAL FIELD

The present invention is related to portable terminals such as mobile phones, and particularly to preventing operating error caused by erroneous contact on a touch panel.

### BACKGROUND ART

In recent years, in order to ensure visibility and portability, large screens (touch panels) are being provided that extend right to the edge of casings of mobile phones provided with a touch panel, such as so-called smartphones. Thus, when a user holds a casing, a problem may occur in that the user may accidentally contact the touch panel with a finger, etc., causing a process to be executed unintentionally (hereafter, “operating error”).

To counter this problem, technology exists that prevents operating error by setting a frame-like region of a periphery of the touch panel as a non-sensitive region such that, when communicating with another device for example, icons, etc., within the non-sensitive region do not receive input even if contacted.

### SUMMARY OF INVENTION

### Technical Problem

However, a non-sensitive region that cannot be operated even when the user contacts the touch panel may hinder user operation. Thus, a non-sensitive region is sought that is as small as possible while still appropriately suppressing operating error when a user is holding the portable terminal.

### Solution to Problem

The portable terminal pertaining to one aspect of the present invention is a portable terminal that executes processing corresponding to a contact position on a touch panel, the portable terminal comprising: a detector that detects an orientation change of the portable terminal; and a controller storing information defining a predefined region having a high probability of erroneous contact by a user during the orientation change, the controller disabling input due to contact within the predefined region during a predefined time period after detection of the orientation change, the predefined region being within a portion of a peripheral region of the touch panel.

### Advantageous Effects of Invention

The portable terminal that is one aspect of the present invention, by means of the above configuration, appropriately suppresses operating error when a user is holding the portable terminal.

### BRIEF DESCRIPTION OF DRAWINGS

FIG. 1 is a frontal view illustrating an outer appearance of a mobile phone pertaining to an embodiment of the present invention.

FIG. 2 is a diagram illustrating coordinates defined for a touch panel.

FIG. 3A illustrates a first orientation change, and FIG. 3B illustrates a second orientation change.

FIG. 4A illustrates a third orientation change, and FIG. 4B illustrates a fourth orientation change.

FIG. 5 is a diagram illustrating reference axes pertaining to rotation.

FIG. 6 is a diagram for describing rotation angle θ.

FIG. 7A to FIG. 7E are diagrams for describing transition of gripping points in the first orientation change.

FIG. 8A to FIG. 8E are diagrams for describing transition of gripping points in the second orientation change.

FIG. 9 is a block diagram illustrating functional elements of a main part of the mobile phone.

FIG. 10 is a diagram for describing detection of an orientation change.

FIG. 11A is an example of a non-sensitive region table and FIG. 11B illustrates a coordinate conversion table.

FIG. 12 is an example of a rotation detection table.

FIG. 13 is a flowchart illustrating rotation processing.

FIG. 14A illustrates a first orientation change pertaining to a modification of the present invention and FIG. 14B illustrates a second orientation change pertaining to the modification of the present invention.

FIG. 15 is an example of a contact position history table pertaining to a modification of the present invention.

### EMBODIMENT

The following describes, with reference to the drawings, a mobile phone as an embodiment of a portable terminal pertaining to the present invention.

1. Overview

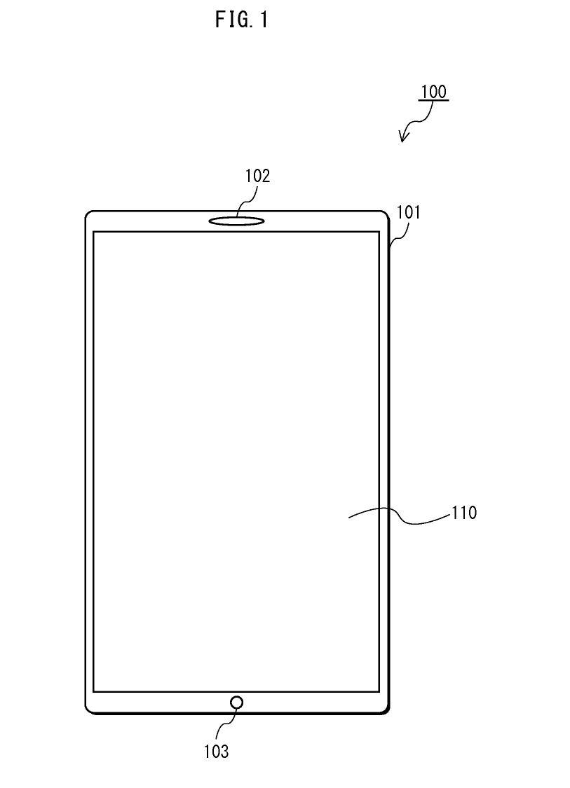

FIG. 1 is a frontal view illustrating an outer appearance of a mobile phone 100.

The mobile phone 100 is a so-called smartphone, and as illustrated in the diagram, a receiver 102, a microphone 103, and a touch panel 110 are positioned on a face of a flat casing 101.

In the mobile phone 100, a viewable area and an area that can be operated by contact are enlarged by positioning the touch panel 110 to be in close proximity to edges of the casing 101. However, by narrowing edge portions of the casing 101, probability increases of a user unintentionally also touching the touch panel 110 when holding the edge portions of the casing 101.

In particular, when using a smartphone, a user often switches between using an application suitable for a portrait screen and using an application suitable for a landscape screen. At such a time, the user rotates the casing 101 so that from the user's point of view the touch panel 110 becomes a portrait screen or a landscape screen. When the casing 101 is rotated, the user fails to pay attention more often than when normally holding the smartphone, which may cause erroneous contact and accompanying operating error.

In order to suppress such operating error, the mobile phone 100 sets a portion of a peripheral region of the touch panel 110 as a non-sensitive region depending on an orientation change due to rotation of the casing 101. Specifically, for each of a plurality of orientation changes, a region that is easy to erroneously contact by a user is set as a non-sensitive region. When contact is detected at such a non-sensitive region, even if a display object such as an icon is being displayed at a contact position, processing associated with the display object is not executed. In other words, even if contact is made in the non-sensitive region, processing related to a detection signal in response to the contact is disabled.

Here, the non-sensitive region is a region which the user cannot operate by touch, and because this hinders user operation, the non-sensitive region is preferably as small as possible. The portable terminal pertaining to the present embodiment does not set the entirety of a frame-like region of a periphery of a touch panel as a non-sensitive region, and instead sets a region along a long side of the touch panel 110 and a region along a short side of the touch panel 110 as the non-sensitive region, thereby avoiding operating error while ensuring as much area as possible of the touch panel 110 can be operated by the user.

2. Non-Sensitive Region

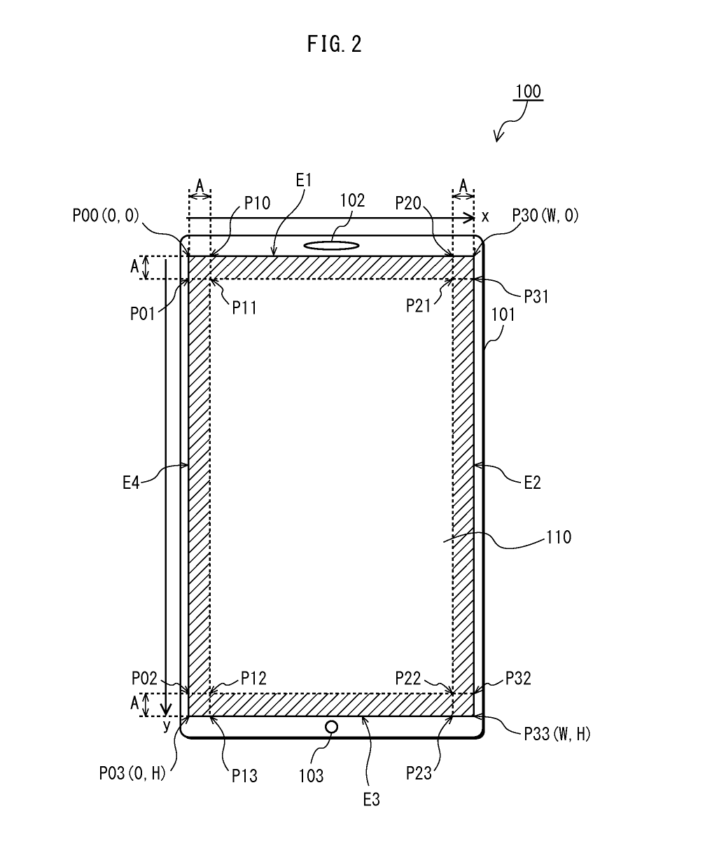

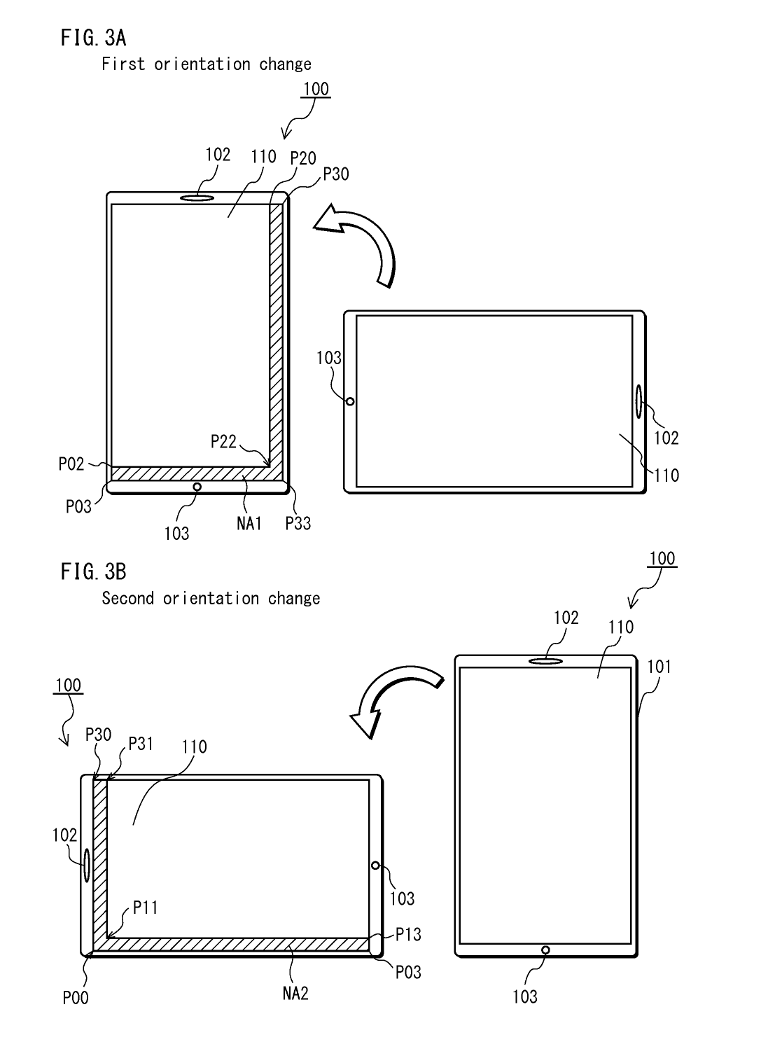

The non-sensitive region of the present embodiment is illustrated by hatching in FIG. 2 as an example. The non-sensitive region is set within a frame-like region of width A of the periphery of the touch panel 110. The non-sensitive region does not occupy the entire frame-like region mentioned above. For example, the non-sensitive region has any shape such as an L-shape indicated by hatching in FIG. 3A.

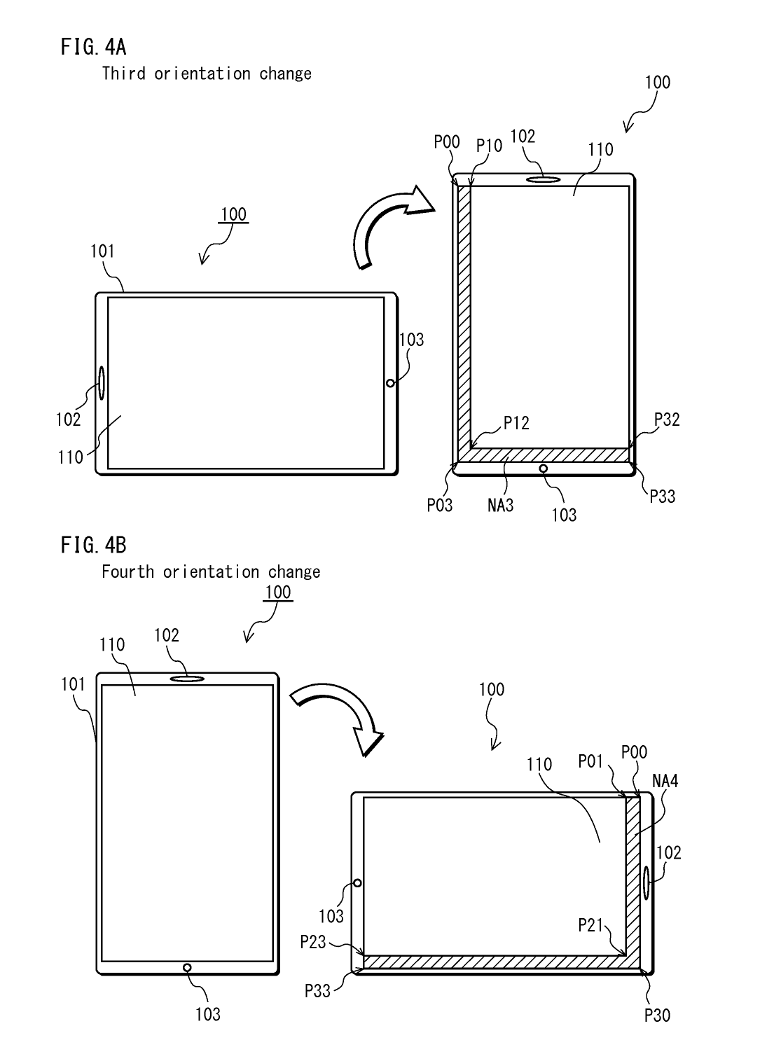

During a period in which the non-sensitive region is enabled (hereafter, “non-sensitive region enabled period”), when contact is detected at non-sensitive regions 1-4 (NA1-NA4) indicated in FIG. 3A, FIG. 3B, FIG. 4A, and FIG. 4B, even if a display object such as an icon is being displayed at the contact position, processing associated with the display object is not executed.

2-1. Coordinates

In the present embodiment, coordinates are used for defining the non-sensitive region. For example, a rectangular non-sensitive region is defined by a coordinate of an upper-left corner of the rectangle and a coordinate of a lower-right corner of the rectangle.

Coordinates use an upper-left corner of a display area of the touch panel 110 when the mobile phone 100 is in a basic orientation as an origin point (P00), and are expressed as a set of an x-coordinate and a y-coordinate (x, y) of a coordinate system having an x-axis aligned along a horizontal direction along an upper edge of the touch panel 110 and a y-axis aligned vertically downwards.

In the present embodiment, the “basic orientation” is an orientation in which the mobile phone 100 is standing in the vertical direction, and as an example, as illustrated in FIG. 2, an orientation in which the microphone 103 is positioned vertically downwards from the receiver 102.

Coordinate points used in defining the non-sensitive region, etc., are described below using FIG. 2. Note that the display area of the touch panel 110 has a size W in the x-axis direction and a size H in the y-axis direction. Further, E1 in FIG. 2 indicates the upper edge of the touch panel 110 in the basic orientation, E2 indicates a right edge, E3 indicates a lower edge, and E4 indicates a left edge.

The coordinate point P00 is the origin point and has coordinates (0, 0).

Coordinate points P10, P20, and P30 have coordinates (A, 0), (W-A, 0), and (W, 0), respectively.

Coordinate points P01, P11, P21, and P31 have coordinates (0, A), (A, A), (W-A, A), and (W, A).

Coordinate points P02, P12, P22, and P32 have coordinates (0, H-A), (A, H-A), (W-A, H-A), and (W, H-A).

Coordinate points P03, P13, P23, and P33 have coordinates (0, H), (A, H), (W-A, H), and (W, H).

2-2. Rotation

In the present embodiment, the non-sensitive region is determined depending on orientation change by rotation of the casing 101. The following describes “rotation”.

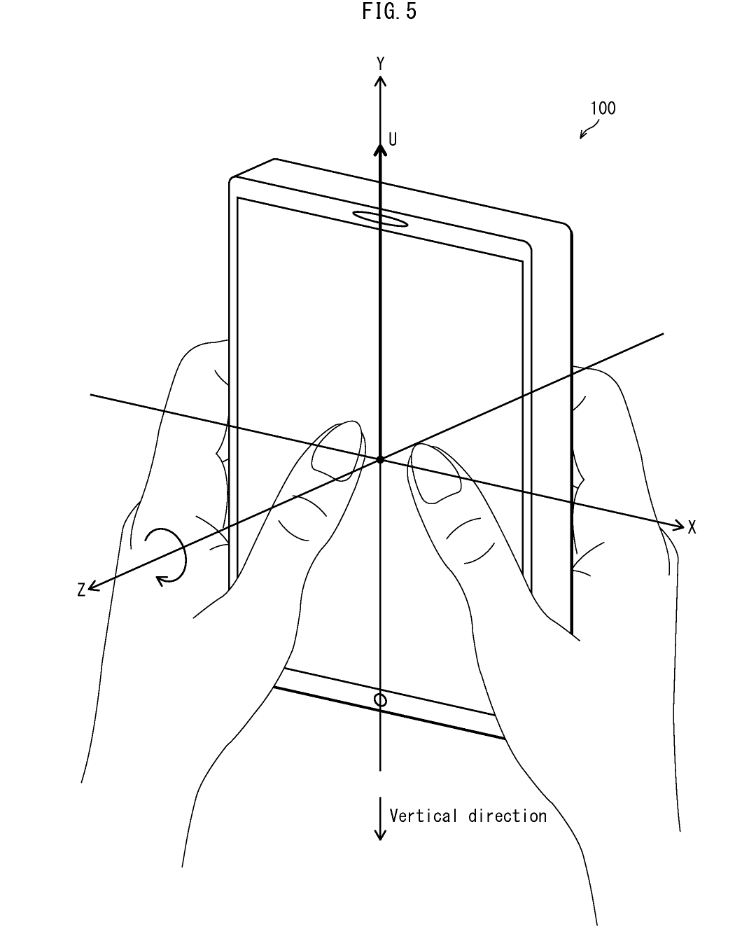

FIG. 5 is a diagram for describing the X-axis, Y-axis, and Z-axis, which are reference axes for defining rotation.

The Y-axis is an axis in a vertical upwards direction that passes through a center point of a surface of the touch panel 110, as illustrated in FIG. 5.

The X-axis is an axis perpendicular to the Y-axis and passes through the center point of the surface of the touch panel 110, as illustrated in FIG. 5.

The Z-axis is an axis perpendicular to both the X-axis and the Y-axis and passes through the center point of the surface of the touch panel 110, as illustrated in FIG. 5. The mobile phone 100 detects rotation about the Z-axis.

An axis perpendicular to E1 of the touch panel 110 that passes through the center point of the surface of the touch panel 110 is defined as a U-axis. When the mobile phone 100 is in the basic orientation, the Y-axis and the U-axis coincide.

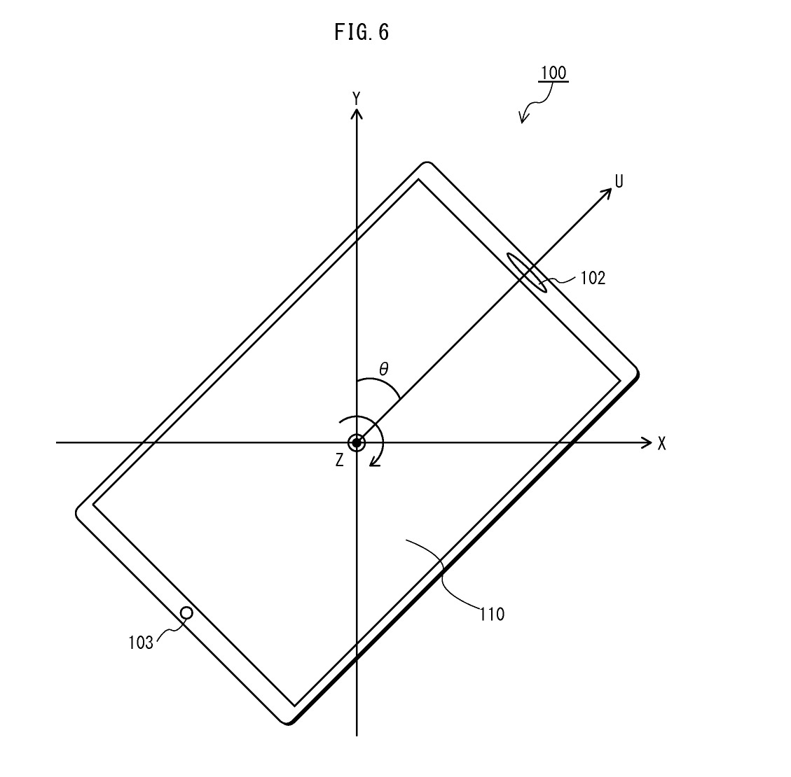

As illustrated in FIG. 6, when the mobile phone 100 is rotated about the Z-axis, an angle between the U-axis and the Y-axis is defined as a rotation angle θ.

2-3. Non-Sensitive Region Corresponding to Orientation Change

The following describes the non-sensitive region set when orientation change is detected.

In the present embodiment, orientation change is defined by the rotation angle and a rotation direction. The non-sensitive region in the present embodiment assumes the user is right-handed.

In the present embodiment, the “non-sensitive region enabled period” is a predefined period from when an orientation change is detected (for example, two seconds in the present embodiment).

(1) First Orientation Change

An example of the first orientation change, as illustrated in FIG. 3A, is a change from an orientation in which θ=90° to an orientation in which θ=0° (the basic orientation).

The mobile phone 100, when the first orientation change is detected, enables the non-sensitive region NA1 during the non-sensitive region enabled period.

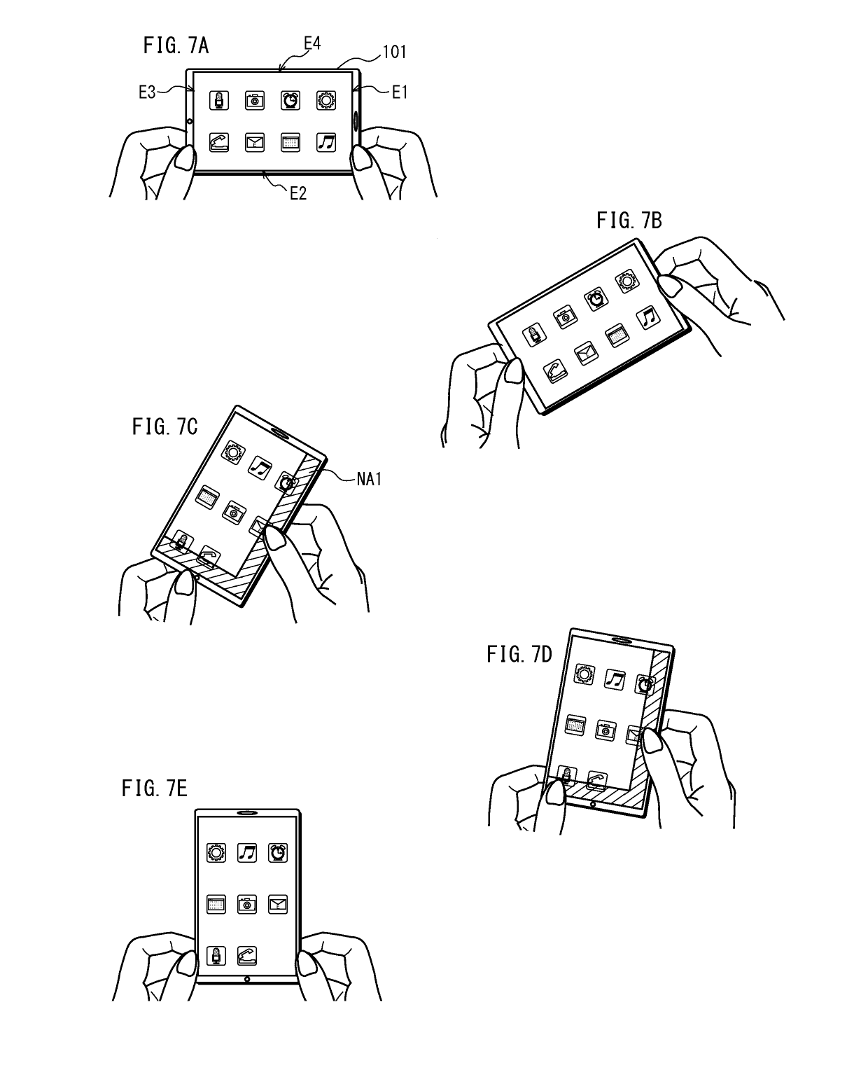

When the first orientation change is performed on the mobile phone 100, a sequence of gripping the casing 101 by the user is assumed as illustrated in FIG. 7A to FIG. 7E. The non-sensitive region NA1 is defined as a region that is easily erroneously contacted at such a time.

As indicated in FIG. 7A, when starting the first orientation change, the user grips a lower portion of E3 (near E2) with their left hand, grips a lower portion of E1 (near E2) with their right hand, and maintains the orientation in which θ=90°.

Subsequently, as indicated in FIG. 7B, the user starts rotating the casing 101 anticlockwise.

Subsequently, as indicated in FIG. 7C, when the rotation angle changes to a value in a predefined range, the mobile phone 100 determines that the first orientation change is detected from the rotation angle and the rotation direction and enables the non-sensitive region NA1. At such time, the non-sensitive region enabled period starts.

The user changes their grip, transferring their right hand from El to E2 of the casing 101 in order to easily exert force to stand the casing 101 upright.

As this time, even if a finger, etc., of the right hand of the user contacts an icon, etc., in the non-sensitive region NA1, operating error does not occur.

Subsequently, as illustrated in FIG. 7D, the user moves their left hand towards E4 while continuing to rotate the casing 101.

Subsequently, as illustrated in FIG. 7E, when nearing an orientation in which θ=0°, the user changes their grip so that their left hand grips a lower portion of E4 (near E3) and their right hand grips a lower portion of E2 (near E3).

When the non-sensitive region enabled period elapses, the mobile phone 100 disables the non-sensitive region NA1.

(2) Second Orientation Change

An example of the second orientation change, as illustrated in FIG. 3B, is a change from an orientation in which θ=0° (the basic orientation) to an orientation in which θ=270°.

The mobile phone 100, when the second orientation change is detected, enables the non-sensitive region NA2 during the non-sensitive region enabled period.

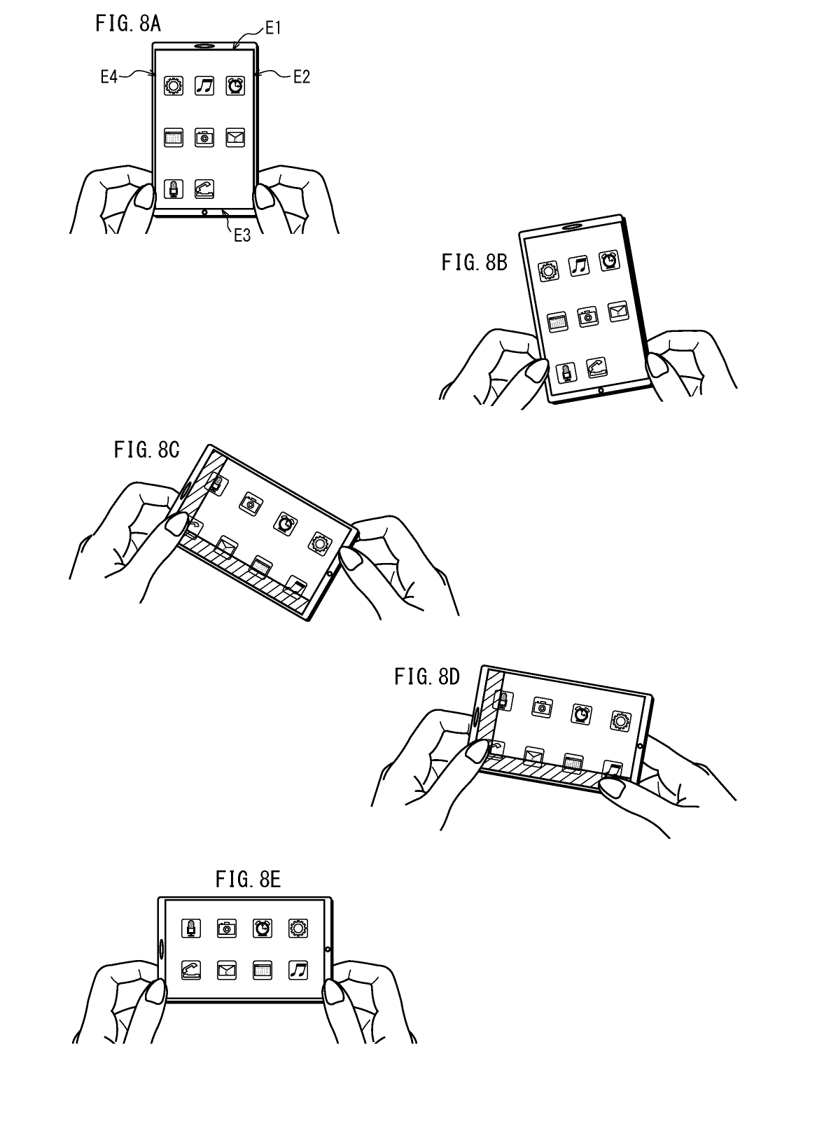

When the second orientation change is performed on the mobile phone 100, a sequence of gripping the casing 101 by the user is assumed as illustrated in FIG. 8A to FIG. 8E. The non-sensitive region NA2 is defined as a region that is easily erroneously contacted at such a time.

As indicated in FIG. 8A, when starting the second orientation change, the user grips a lower portion of E4 (near E3) with their left hand, grips a lower portion of E2 (near E3) with their right hand, and maintains the orientation in which θ=0°.

Subsequently, as indicated in FIG. 8B, the user starts rotating the casing 101 anticlockwise.

Subsequently, as indicated in FIG. 8C, when the rotation angle changes to a value in a predefined range, the mobile phone 100 determines that the second orientation change is detected from the rotation angle and the rotation direction and enables the non-sensitive region NA2. At such time, the non-sensitive region enabled period starts.

The user changes their grip, moving their left hand from E4 to El to easily support the casing 101 as it is rotated.

As this time, even if a finger, etc., of the left hand of the user contacts an icon, etc., in the non-sensitive region NA2, operating error does not occur.

Subsequently, as illustrated in FIG. 8D, the user moves their right hand to a lower portion of E3 (near E4) while continuing to rotate the casing 101.

Subsequently, as illustrated in FIG. 8E, when nearing an orientation in which θ=270°, the user changes their grip so that their left hand grips a lower portion of E1 (near E4) and their right hand grips a lower portion of E3 (near E4).

When the non-sensitive region enabled period elapses, the mobile phone 100 disables the non-sensitive region NA2.

(3) Third Orientation Change

The third orientation change is a change from an orientation in which θ=270° to an orientation in which θ=0°.

The mobile phone 100, when the third orientation change is detected, enables the non-sensitive region NA3 during the non-sensitive region enabled period.

The non-sensitive region NA3 is defined as a region that is easily erroneously contacted by the user during the third orientation change.

Gripping the casing 101 during the third orientation change is similar to gripping the casing 101 during the first orientation change, and is therefore not described here.

(4) Fourth Orientation Change

The fourth orientation change is a change from an orientation in which θ=0° to an orientation in which θ=90°.

The mobile phone 100, when the fourth orientation change is detected, enables the non-sensitive region NA4 during the non-sensitive region enabled period.

The non-sensitive region NA4 is defined as a region that is easily erroneously contacted by the user during the fourth orientation change.

Gripping the casing 101 during the fourth orientation change is similar to gripping the casing 101 during the second orientation change, and is therefore not described here.

3. Elements

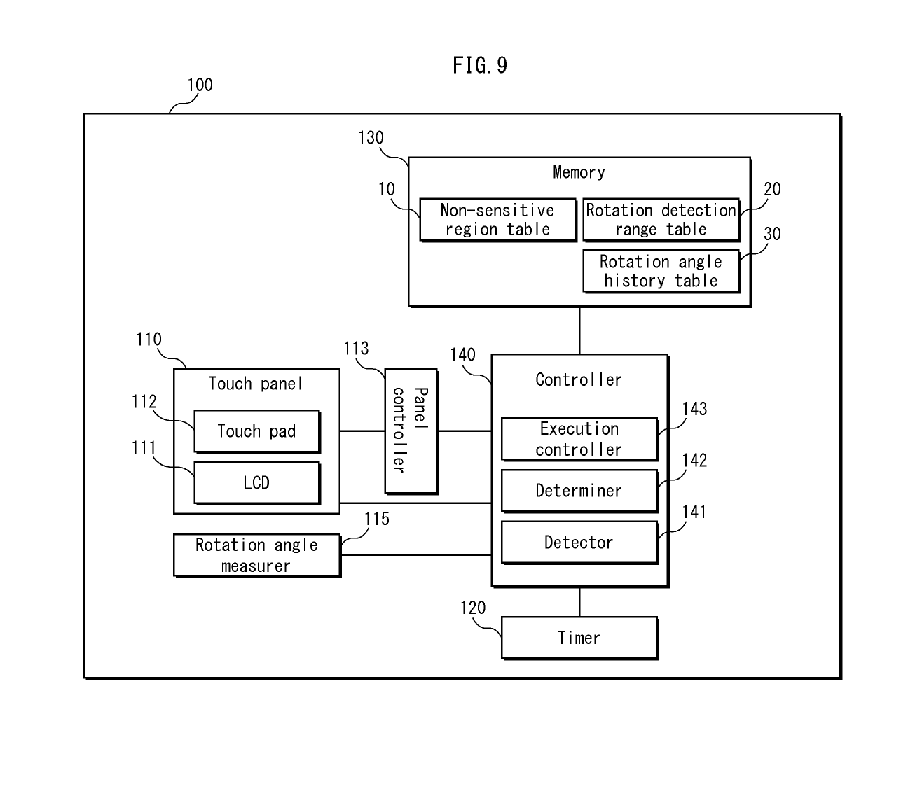

FIG. 9 is a block diagram illustrating functional elements of a main part of the mobile phone 100.

As illustrated in the diagram, the mobile phone 100 includes the touch panel 110, a panel controller 113, a rotation angle measurer 115, a timer 120, a memory 130, and a controller 140.

Note that the mobile phone 100 includes a processor and memory, and functions of the controller 140 are implemented by execution of programs stored in the memory by the processor. Further, although not illustrated, the mobile phone 100 includes elements for implementing functions of a typical mobile phone such a telephone function, an e-mail function, etc.

Touch Panel 110

The touch panel 110 includes a liquid crystal display (LCD) 111 and a touch pad 112. Note that in the present embodiment, the number of pixels of the LCD 111 is assumed, as an example, to be 480 pixels horizontally by 800 pixels vertically (in the basic orientation).

The touch pad 112 is an electrostatic capacitance type of touch sensor and is overlaid on a face of the LCD 111. The touch pad 112 is composed of light-transmissive material, and is composed so that an image displayed on the LCD 111 is visible.

Panel Controller 113

The panel controller 113 is an integrated circuit (IC) that detects contact of a finger, etc., of the user on the touch pad 112, and while detecting such contact, outputs coordinate values (x, y) of the contact position on the touch pad 112 to the controller 140 at regular time intervals (for example, 25 ms).

Rotation Angle Measurer 115

The rotation angle measurer 115 includes a b 3-axis acceleration sensor, a gyro sensor, and a measurement result processor, and has a function of measuring the rotation angle θ (hereafter, “rotation angle measurement function”).

The 3-axis acceleration sensor measures a tilt at predefined time intervals, using a vertical downward direction when the user has not performed a rotation operation on the casing 101 as a reference, and outputs the measurement to the measurement result processor. Whether or not the rotation operation is performed is determined by whether or not the gyro sensor detects angular acceleration.

The gyro sensor measures angular acceleration pertaining to rotation about the Z-axis at predefined time intervals, and outputs the measurement to the measurement result processor.

The measurement result processor converts, by calculation, the tilt measurement outputted by the 3-axis acceleration sensor to a tilt measured from a vertically upward direction with the Z-axis as a centre point (hereafter, “casing tilt angle”).

Further, the measurement result processor, by integral processing of the angular acceleration measurement outputted by the gyro sensor, calculates the rotation angle from the start of the rotation operation (hereafter, “rotation operation angle”). Subsequently, the measurement result processor calculates the rotation angle θ by adding the rotation operation angle to the casing tilt angle prior to starting the rotation operation, and transmits the rotation angle θ to the controller 140.

Note that the measurement result processor determines that the rotation operation has started when a value of the angular acceleration received from the gyro sensor is greater than or equal to a predefined value, and determines that the rotation operation has stopped when a value of the angular acceleration is less than the predefined value.

Timer 120

The timer 120 is a timer and has functions of starting timing according to an instruction from the controller 140 and, when a specified time has been timed, notifying the controller 140.

Memory 130

The memory 130 is composed of non-volatile memory and is a memory region for storing various programs for applications executed by the mobile phone 100 (for example, a communication application, an e-mail application, a web browser, etc.), other data required by such applications, a non-sensitive region table 10, a rotation detection range table 20, and a rotation angle history table 30.

Controller 140

The controller 140 has functions of a typical a mobile phone and a function of controlling rotation processing.

The controller 140 includes a detector 141, a determiner 142, and an execution controller 143.

(1) Detector 141

The detector 141 has a function of detecting contact on the touch panel 110 by acquiring a coordinate value transmitted from the panel controller 113.

(2) Determiner 142

The determiner 142 has an orientation change detection function.

The orientation change detection function is implemented by the following processing.

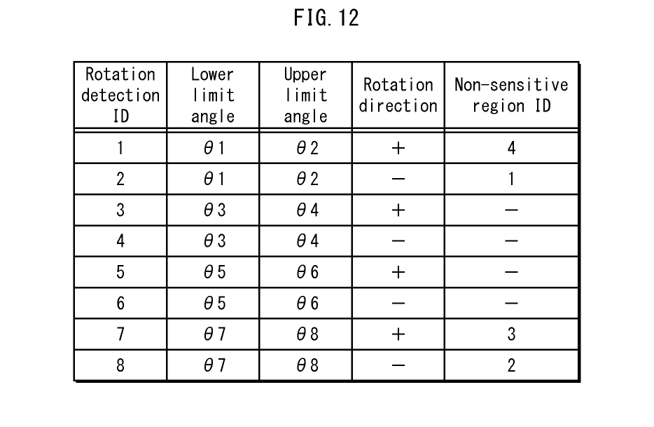

The determiner 142 determines, when the rotation angle θ and the rotation direction are acquired from the rotation angle measurer 115, whether or not the rotation angle θ is no less than a lower limit and no greater than an upper limit of a rotation detection range table entry in the rotation detection range table 20 (see FIG. 12).

When the rotation angle θ is determined to be no less than the lower limit and no greater than the upper limit of a rotation detection range table entry, the determiner 142 determines the rotation direction of the casing 101 when the rotation angle θ changes to a value in the rotation detection range.

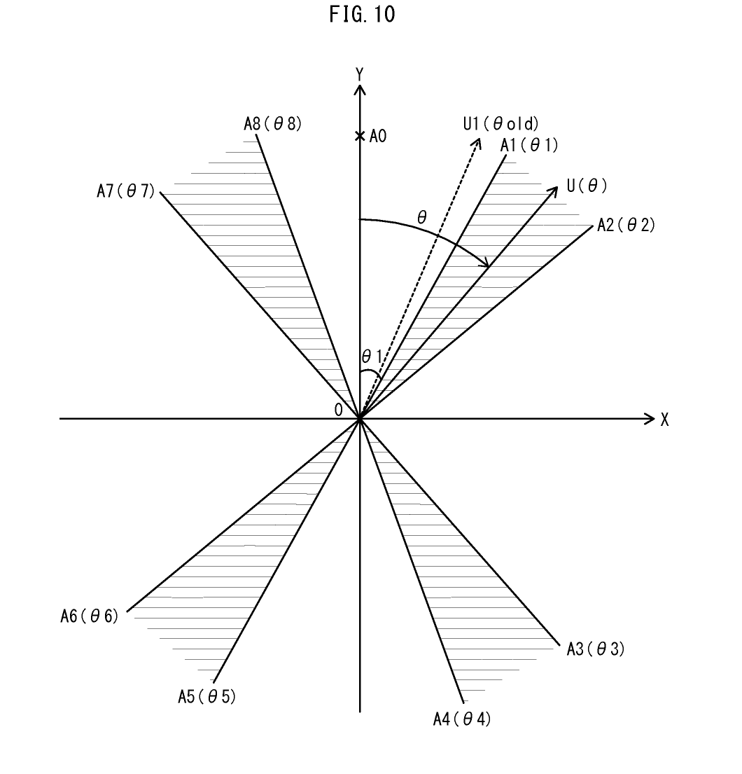

FIG. 10 is a diagram for describing detection of an orientation change.

When the rotation angle θ is detected as having changed to a value in the rotation detection range (within the lower limit and the upper limit), the determiner 142 transmits to the execution controller 143 a non-sensitive region ID defined by the rotation detection range and the rotation direction.

The rotation direction is determined from a direction of transition from the rotation angle detected prior to becoming a value in the rotation detection range (hereafter, “first rotation angle”) to the rotation angle detected in the rotation detection range (hereafter, “second rotation angle”). In other words, the rotation direction is determined by a sign of a subtraction result obtained by subtracting the first rotation angle from the second rotation angle.

When the sign of the subtraction result is positive, the rotation direction is “+”, and when the subtraction result is negative, the rotation direction is “−”.

For example, FIG. 10 shows a case in which the first rotation angle is “θold” and the second rotation angle is θ. In this case, θ is between A1 and A2, and because θold (first rotation angle) is less than θ, the rotation direction is +.

In this case, the detected orientation change is the fourth orientation change and the non-sensitive region enabled has a non-sensitive region ID of 4 (see FIG. 12).

Note that θ1 to θ8 in FIG. 10 correspond to θ1 to θ8 in FIG. 12.

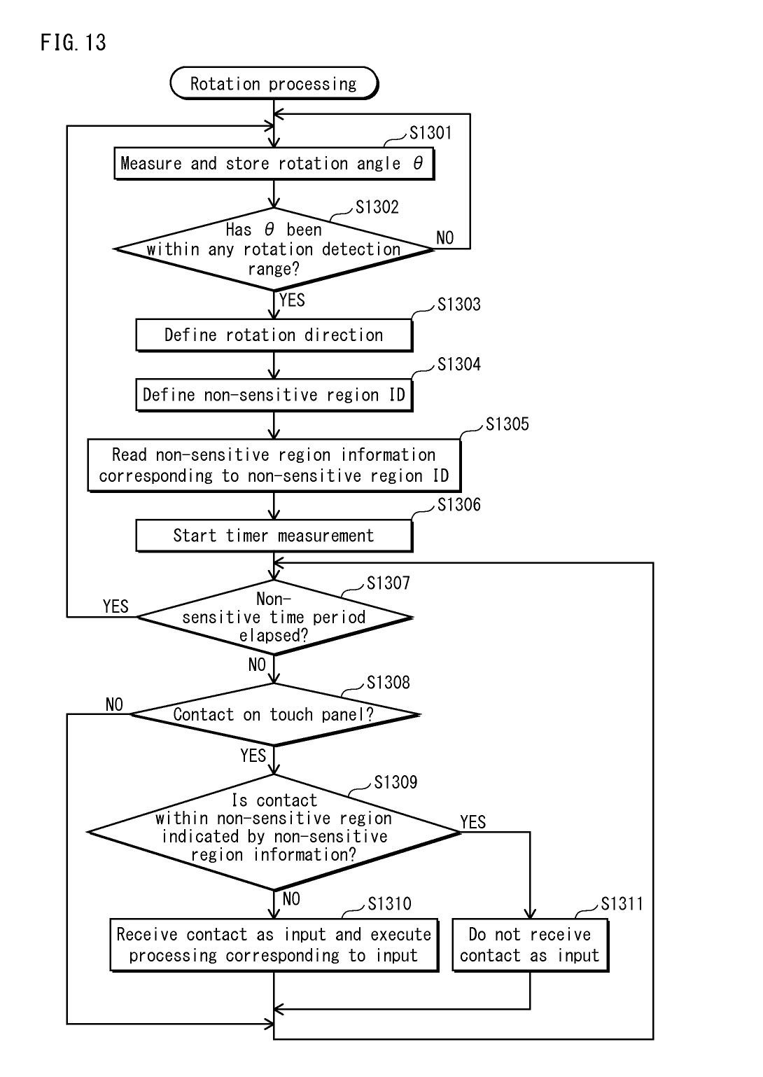

Processing due to the orientation change detection function corresponds to S1302 to S1304 in FIG. 13.

(3) Execution Controller 143

The execution controller 143 has a function of reading from the memory 130 and executing programs for various applications in response to user operations, and a function of controlling whether or not processing in response to contact detected by the detector 141 is executed, according to a determination result by the determiner 142 (hereafter, “processing execution control function”).

The processing execution control function is implemented by the following processing.

The execution controller 143 transmits the non-sensitive region ID from the determiner 142.

Subsequently, upon receiving the non-sensitive region ID, the execution controller 143 specifies a predefined non-sensitive region enabled period (for example, 2 seconds) to the timer 120.

Subsequently, but prior to receiving a notification from the timer 120 that the non-sensitive region enabled period has elapsed, the execution controller 143 performs the following control when receiving a notification from the panel controller 113 that the touch panel 110 has been contacted.

The execution controller 143 determines whether or not coordinates of the contact position on the touch panel are coordinates within a non-sensitive region that is enabled, and when the coordinates of the contact position are within such a non-sensitive region, the execution controller 143 does not accept the contact on the touch panel as input. On the other hand, when the coordinates of the contact position on the touch panel are outside the non-sensitive region that is enabled, the execution controller 143 accepts the contact on the touch panel as input.

When the contact is accepted as input, the execution controller 143 performs processing according to the input. For example, when the contact position is a position in which an icon is being displayed, the execution controller 143 executes an application associated with the icon.

When the contact is not accepted as input, even when the contact position is a position in which an icon is being displayed, the execution controller 143 does not execute an application associated with the icon.

Processing due to the processing execution control function corresponds to S1305 to S1311 in FIG. 13.

4. Data Structure

(1) Non-Sensitive Region Table 10

The non-sensitive region table 10 is information for defining ranges of non-sensitive regions.

Each line of the non-sensitive region table (hereafter, each line except for the item name line is referred to as a “non-sensitive region table entry”) corresponds to one non-sensitive region.

Each non-sensitive region table entry includes a non-sensitive region ID and a non-sensitive region range.

The non-sensitive region ID is an ID for identifying a non-sensitive region group.

Each non-sensitive region range indicates a range of a non-sensitive region.

When the non-sensitive region is non-rectangular, such as an L-shape, etc., the non-sensitive region range is defined by a combination of portion regions that are rectangular.

A portion region that is rectangular is a shape defined by portion region information, which is a set of a coordinate of an upper-left corner of a rectangle and a coordinate of a lower right corner of a rectangle.

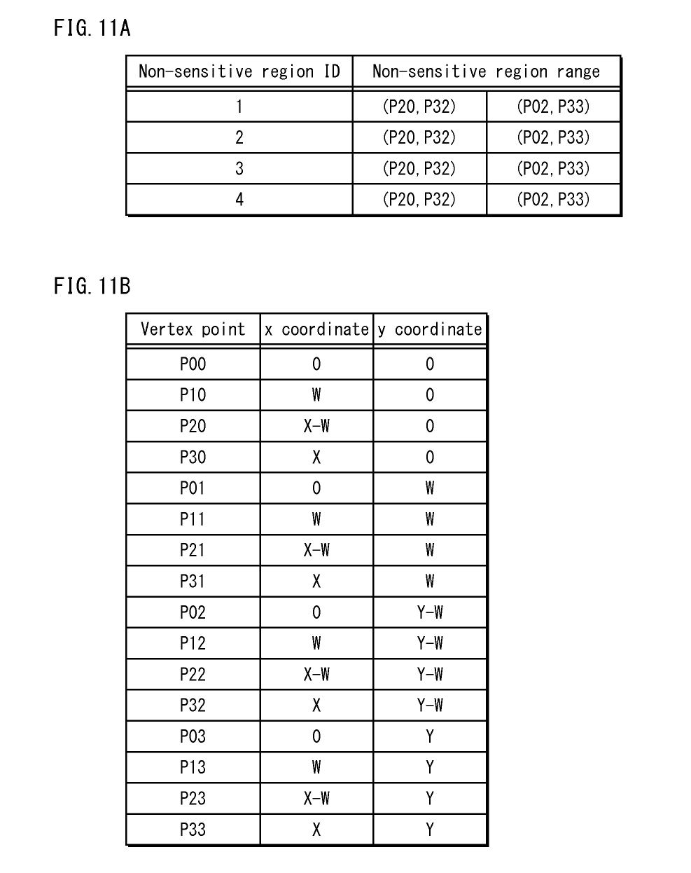

FIG. 11A illustrates an example of the non-sensitive region table 10.

The non-sensitive region table entry at line 1 of the non-sensitive region table 10 has a non-sensitive region ID of 1 and defines a non-sensitive region composed of two portion regions defined by portion region information (P20, P32) and (P02, P33).

The portion region information (P20 P32) indicates a portion region having an upper left coordinate of P20 and lower right coordinate of P32.

Each coordinate, for convenience, is expressed as a vertex name such as P20 rather than in a format such as (x, y). Correspondence between the vertex name and (x, y) coordinates is shown in the coordinate conversion table in FIG. 11B.

(2) Rotation Detection Range Table 20

The rotation detection range table 20 is information for defining rotation detection ranges for detecting rotation.

Each line of the rotation detection range table (hereafter, each line except for the item name line is referred to as a “rotation detection range table entry”) corresponds to one rotation detection range.

A rotation detection range table entry includes a rotation detection ID, a lower limit angle, an upper limit angle, a rotation direction, and a non-sensitive region ID.

The rotation detection ID is an ID for identifying a rotation detection range.

The lower limit angle is a lower limit angle of a rotation detection range.

The upper limit angle is an upper limit angle of a rotation detection range.

When the rotation angle θ detected by the rotation angle measurer 115 is no less than a lower limit angle and no greater than a corresponding higher limit angle, it is determined that rotation is detected by the determiner 142.

The rotation direction indicates a clockwise rotation direction by “+” and an anticlockwise rotation direction by “−”.

The non-sensitive region ID is an ID for identifying a non-sensitive region group to be enabled.

FIG. 12 illustrates an example of the rotation detection range table 20.

As an example, as illustrated in the diagram, the rotation detection range table entry in the first line of the rotation detection range table 20 has a rotation detection ID of 1, a lower limit angle of θ1, an upper limit angle of θ2, a rotation direction of +, and a non-sensitive region ID of 4.

θ1 to θ8 may be defined, for example, such that θ1=30°, θ2=60°, θ3=120°, θ4=150°, θ5=210°, θ6=240°, θ7=300°, and θ8=330°, but θ1 to θ8 are not limited in this way. θ1 to θ8 may be any angles appropriate for detecting rotation.

(3) Rotation Angle History Table 30

The rotation angle history table 30 stores as a history a predefined number (for example, five) of rotation angles θ measured by the rotation angle measurer 115.

The rotation angle history table 30 specifically records a predefined number of sets of a calculation time of a rotation angle θ paired with a corresponding calculated rotation angle θ.

5. Operation

FIG. 13 is a flowchart illustrating a flow of rotation processing by the mobile phone 100 described above.

First, the rotation angle measurer 115 in the mobile phone 100 measures the rotation angle θ at predefined time intervals (S1301). Subsequently, the rotation angle measurer 115 outputs the rotation angle θ to the determiner 142 of the controller 140 and writes the rotation angle θ to the rotation angle history table 30.

Subsequently, the determiner 142 determines whether or not θ has been within a rotation detection range by using the orientation change detection function (S1302), and when the determiner 142 determines that θ has not been within a rotation detection range (NO at S1302), processing proceeds to S1301.

On the other hand, when θ has been within a rotation detection range (YES at S1302), the determiner 142 defines the rotation direction by using the orientation change detection function (S1303).

Subsequently, using the non-sensitive region detection function and based on the orientation change and the rotation direction, the determiner 142 determines the non-sensitive region to be set and notifies the execution controller 143 of the non-sensitive region ID of the non-sensitive region so determined (S1304).

The execution controller 143 reads from the non-sensitive region table 10 the non-sensitive region range corresponding to the non-sensitive region ID (S1305).

Subsequently, the execution controller 143 sets the timer 120 to start timing the non-sensitive region enabled period (2 seconds) (S1306).

The timer 120 notifies the execution controller 143 when the non-sensitive region enabled period has elapsed.

The execution controller 143, when not notified that the non-sensitive region enabled period has elapsed (NO at S1307), determines whether or not contact is made on the touch panel(S1308), and when no contact is made (NO at S1308), processing proceeds to S1307.

When the execution controller 143 determines that contact is made on the touch panel 110 (YES at S1308), the execution controller 143 determines whether or not the contact position on the touch panel 110 is within a region defined by region information pertaining to the non-sensitive region read from the non-sensitive region table 10 (S1309).

When the contact position is within such a region (YES at S1309), the contact is not received as input (S1311), and processing proceeds to S1307.

When the contact position is not within such a region (NO at S1309), the contact is received as input, the execution controller executes processing corresponding to the input (S1310), and processing proceeds to S1307.

6. Modifications

The above describes an embodiment of the portable terminal pertaining to the present invention, but the portable terminal may be modified as follows and the present invention is of course not limited to the portable terminal indicated in the above embodiment.

(1) In the above embodiment, the non-sensitive region is an L-shaped region, but other shapes may be used.

For example, when the non-sensitive region is an ellipse, the non-sensitive region is defined by coordinates of the center of the ellipse and coordinates of the two foci of the ellipse. When the non-sensitive region is a circle, the non-sensitive region is defined by coordinates of the center of the circle and the radius.

Further, the non-sensitive region may be composed of three or more portion regions.

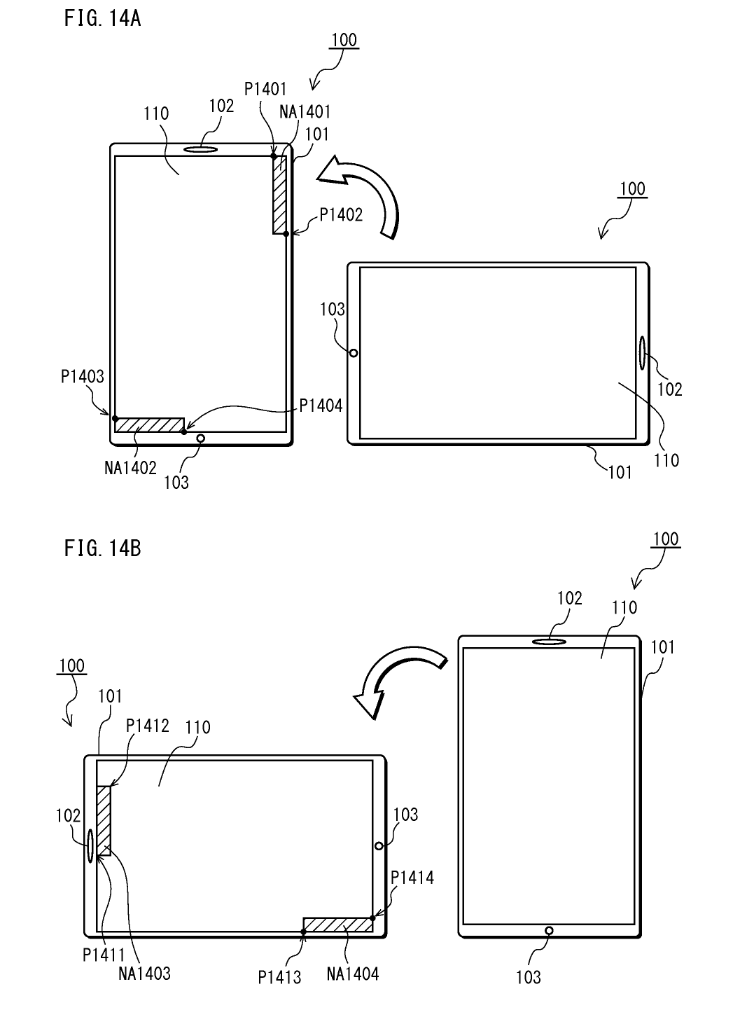

Further, the non-sensitive region is not limited to being an L-shaped region, and need not be a continuous region, as indicated by NA1401 and NA1402 in FIG. 14A, which illustrates a modification of the first orientation change.

In such a case, NA1401 and NA1402 can be defined by coordinate points P1401, P1402, P1403, and P1404.

Also with respect to the second orientation change, the non-sensitive region need not be a continuous region, as indicated by NA1403 and NA1404 in FIG. 14B, which illustrates a modification of the second orientation change.

In such a case, NA1403 and NA1404 can be defined by coordinate points P1411, P1412, P1413, and P1414.

Also with respect to the third orientation change and the fourth orientation change, the non-sensitive region need not be a continuous region in the same way as the first orientation change and the second orientation change.

(2) In the embodiment above, the non-sensitive region is predefined, but the non-sensitive region may be derived by using user habits (the contact history of contacts on the touch pad when the casing 101 is rotated during the non-sensitive region enabled period), etc.

For example, the mobile phone 100 may be provided with a learning mode for learning with respect to the non-sensitive region. In the learning mode, the controller 140, after detecting the orientation change and during the non-sensitive region enabled period, causes contact positions on the touch panel 110 to be recorded in the memory 130 as a contact position history table. After exiting the learning mode, for each of the orientation changes, a region including the contact position recorded as contact history is defined as a non-sensitive region. The non-sensitive region may have a minimum area including all the contact positions, and may have an area larger than the minimum area.

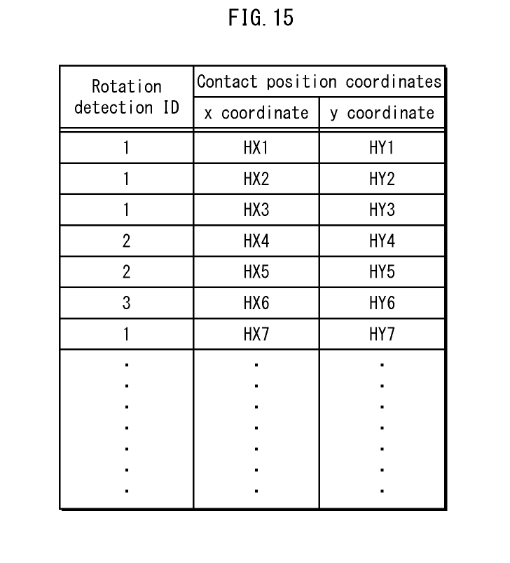

FIG. 15 illustrates an example of the contact position history table.

Each line of the contact position history table (hereafter, each line except for the item name line is referred to as a “contact position history table entry”) corresponds to one contact position history.

The contact position history table entry includes the rotation detection ID and contact position coordinates.

The rotation detection ID is the same as the rotation detection ID in the rotation detection range table entry.

The contact position coordinates are composed of an x coordinate and a y coordinate of a contact position by a user on the touch panel 110.

Note that contact positions recorded as contact position history table entries need not all be used. For example, among contact positions that are recorded, a range of the non-sensitive region may be defined by using only contact positions that have been contacted no less than a predefined number of times.

(3) In the embodiment above, four orientation changes are defined from the first orientation change to the fourth orientation change, in which the rotation angle is 90°, but the present invention is not limited in this way. For example, other rotation angles may be used, and the number of orientation changes may be three or less or five or more.

For example, in a case in which an application rotates an image displayed on the touch panel 110 by 45°, a change in rotation angle of 45° may be defined as an orientation change. In such a case, as one example, in the rotation detection range table entry on the first line of the rotation detection range table 20, θ1=10°, θ2=35°, the rotation direction is + and the non-sensitive region ID is 4.

Further, as another example, in a case in which an application rotates an image that is displayed by 180°, a change in rotation angle of 180° may be defined as the only orientation change.

In such a case, as one example, in the rotation detection range table entry on the first line of the rotation detection range table 20, θ1=30°, θ2=150°, and the rotation direction is +. The non-sensitive region set in such a case is a U-shaped region along the edges E1, E2, and E4.

As above, a variety of orientation changes can be defined, and by setting appropriate non-sensitive regions for each of the orientation changes, finer control of non-sensitive regions can be performed.

(4) In the embodiment above, the non-sensitive region enabled period from when an orientation change is detected is, as one example, enabled for two seconds, but the present invention is not limited in this way. The non-sensitive region enabled period is preferably as short as possible in a range in which operating error can be prevented. By simulations, experiments, etc., a preferred period may be obtained and used as the non-sensitive region enabled period.

(5) The non-sensitive region in the embodiment above assumes the user is right-handed. The mobile phone 100 may receive input from a user indicating whether the user is right-handed or left-handed, and when the user is left-handed, the mobile phone 100 may set a region that a left-handed user may erroneously contact as the non-sensitive region. For example, a non-sensitive region for a left-handed user may be a reflection of a non-sensitive region set for a right-handed user, using the Y axis as a line of symmetry.

(6) In the embodiment above, the rotation angle measurer 115 includes both the 3-axis acceleration sensor and the gyro sensor but the rotation angle measurer 115 is satisfied by any configuration that can derive the rotation angle θ. For example, the gyro sensor may be omitted and the 3-axis acceleration sensor may also serve as a gyro sensor.

(7) The control program composed of machine code or program code of a high-level language for causing the processor or circuits connected to the processor of the mobile phone 100 to execute processing such as the rotation processing indicated in the embodiment above may be stored on a storage medium and may be distributed via various communication channels, etc. Such a storage medium is an IC card, hard disk, optical disk, flexible disk, ROM, flash memory, etc. A control program that is distributed is made available by being stored in memory, etc., that is readable by the processor, and by executing the control program the processor realizes each function indicated in the embodiment. Note that the processor, aside from directly executing the control program, may compile and execute the control program or execute the control program via an interpreter.

(8) Each functional element indicated in the embodiment above (the panel controller 113, the rotation angle measurer 115, the timer, 120, the controller 140, etc.) may be implemented as a circuit that executes the function, and may be implemented by execution of a program by one or more processors.

(9) The embodiment above and each modification may be partially combined. 7. Supplement

The following describes elements of the portable terminal as a further embodiment of the present invention and effects of modifications thereof.

(1) The portable terminal pertaining to one embodiment of the present invention is a portable terminal that executes processing corresponding to a contact position on a touch panel, the portable terminal comprising: a detector that detects an orientation change of the portable terminal; and a controller storing information defining a predefined region having a high probability of erroneous contact by a user during the orientation change, the controller disabling input due to contact within the predefined region during a predefined time period after detection of the orientation change, the predefined region being within a portion of a peripheral region of the touch panel.

Further, the detector may further determine that another orientation change different from the orientation change is detected when the rotation angle is no less than another lower limit angle different from the lower limit angle and no greater than another upper limit angle different from the upper limit angle and the rotation direction matches another rotation direction associated with the other lower limit angle and the other upper limit angle, and the controller may disable input due to contact within another predefined region during a predefined time period after detection of the other orientation change, the other predefined region being a portion of the peripheral region of the touch panel that is different from the predefined region.

In this way, the portable terminal appropriately suppresses operating error when a user is holding the portable terminal.

(2) Further, the detector may measure a rotation angle and a rotation direction relative to a predefined orientation of the portable terminal, the detector determining that the orientation change is detected when the rotation angle is no less than a predefined lower limit angle and no greater than a predefined upper limit angle and the rotation direction matches a predefined rotation direction.

In this way, the orientation change is detected by measuring the rotation angle and the rotation direction.

(3) Further, the touch panel may be rectangular and the predefined region, within the peripheral region of the touch panel, may be composed of a region along a long side of the touch panel and a region along a short side of the touch panel.

In this way, within the peripheral region of the touch panel, an area other than a region along a long side of the touch panel and a region along a short side of the touch panel receives contact as input, increasing usability of the portable terminal.

(4 ) Further, the portable terminal may have a learning mode for learning related to the predefined region, and the controller, in the learning mode, may record a contact position of contact on the touch panel within the predefined time period after detection of the orientation change as a contact history associated with the orientation change, and, after the learning mode is exited, set a region including the contact position stored as the contact history as the predefined region.

In this way, regions that a user habitually grips during the orientation change are reflected in the predefined region.

(5) A control method pertaining to one embodiment of the present invention is a control method executed by a portable terminal that executes processing corresponding to a contact position on a touch panel, the control method comprising: detecting an orientation change of the portable terminal; and storing information defining a predefined region having a high probability of erroneous contact by a user during the orientation change and disabling input due to contact within the predefined region during a predefined time period after detection of the orientation change, the predefined region being within a portion of a peripheral region of the touch panel.

A control program pertaining to the embodiment of the present invention is a control program causing a computer to execute functions of a portable terminal that executes processing corresponding to a contact position on a touch panel, the control program causing the computer to execute functions of: a detector that detects an orientation change of the portable terminal; and a controller storing information defining a predefined region having a high probability of erroneous contact by a user during the orientation change, the controller disabling input due to contact within the predefined region during a predefined time period after detection of the orientation change, the predefined region being within a portion of a peripheral region of the touch panel.

In this way, the portable terminal appropriately suppresses operating error when a user is holding the portable terminal.

### INDUSTRIAL APPLICABILITY

The portable terminal pertaining to one embodiment of the present invention is applicable to terminals including a touch panel such as smartphones, having a touch panel extending close to the edges of a casing, non-sensitive regions smaller than conventional non-sensitive regions and suppressing operating error due to erroneous contact when a user holds the casing.

### REFERENCE SIGNS LIST

100 mobile phone

101 casing

102 receiver

103 microphone

110 touch panel

111 LCD

112 touch pad

113 panel controller

115 rotation angle measurer

120 timer

130 memory

140 controller

141 detector

142 determiner

143 execution controller

1. A portable terminal that executes processing corresponding to a contact position on a touch panel, the portable terminal comprising:
a detector configured to detect an orientation change of the portable terminal; and
a memory configured to store information defining a predefined region having a high probability of erroneous contact by a user during the orientation change,
controller configured to disable input due to contact within the predefined region during a predefined time period after detection of the orientation change, the predefined region being within a portion of a peripheral region of the touch panel.

2. The portable terminal of claim 1, wherein
the detector measures a rotation angle and a rotation direction relative to a predefined orientation of the portable terminal about a normal direction of the touch panel, the detector determining that the orientation change is detected when the rotation angle is no less than a predefined lower limit angle and no greater than a predefined upper limit angle and the rotation direction matches a predefined rotation direction.

3. The portable terminal of claim 1, wherein
the touch panel is rectangular, and
the predefined region, within the peripheral region of the touch panel, is composed of a region along a long side of the touch panel and a region along a short side of the touch panel.

4. The portable terminal of claim 1, wherein
the portable terminal has a learning mode for learning related to the predefined region, and
the controller, in the learning mode, records a contact position of contact on the touch panel within the predefined time period after detection of the orientation change as a contact history associated with the orientation change, and, after the learning mode is exited, sets a region including the contact position stored as the contact history as the predefined region.

5. The portable terminal of claim 2, wherein
the detector further determines that another orientation change different from the orientation change is detected when the rotation angle is no less than another lower limit angle different from the lower limit angle and no greater than another upper limit angle different from the upper limit angle and the rotation direction matches another rotation direction associated with the other lower limit angle and the other upper limit angle, and
the controller disables input due to contact within another predefined region during a predefined time period after detection of the other orientation change, the other predefined region being a portion of the peripheral region of the touch panel that is different from the predefined region.

6. A control method executed by a portable terminal that executes processing corresponding to a contact position on a touch panel, the control method comprising:
detecting an orientation change of the portable terminal; and
storing information defining a predefined region having a high probability of erroneous contact by a user during the orientation change and disabling input due to contact within the predefined region during a predefined time period after detection of the orientation change, the predefined region being within a portion of a peripheral region of the touch panel.

7. A control program causing a computer to execute functions of a portable terminal that executes processing corresponding to a contact position on a touch panel, the control program causing the computer to execute functions of:
a detector configured to detect an orientation change of the portable terminal; and
a controller configured to store information defining a predefined region having a high probability of erroneous contact by a user during the orientation change, the controller disabling input due to contact within the predefined region during a predefined time period after detection of the orientation change, the predefined region being within a portion of a peripheral region of the touch panel.
